(19) United States
(12) Patent Application Publication
(10) Pub. No.: US 2011/0072267 A1
(43) Pub. Date: Mar. 24, 2011

(54) METHOD, MOBILE AND NETWORK NODES FOR SHARING CONTENT BETWEEN USERS AND FOR TRACKING MESSAGES

(75) Inventor: Jonas Johansson, Saint Laurent (CA)

(73) Assignee: TELEFONAKTIEBOLAGET LM ERICSSON (PUBL), Stockholm (SE)

(21) Appl. No.: 12/627,789

(22) Filed: Nov. 30, 2009

Related U.S. Application Data
(60) Provisional application No. 61/243,811, filed on Sep. 18, 2009.

(51) Int. Cl. H04L 9/32; H04L 9/08

(52) U.S. Cl. 713/170; 380/278

(57) ABSTRACT

A method for sharing multimedia content protected by RM by a first subscriber with at least one second subscriber of a communication system comprises: receiving the protected multimedia content by the at least one second subscriber from the first subscriber, who previously received the multimedia content; and requesting a license key for unlocking the protected multimedia content by the at least one second subscriber; wherein requesting the license key allows for correlating the license key with the multimedia content.

Furthermore, a method for tracking messages in a communication system comprises: protecting the messages through RM; granting a license key to unlock the protected messages upon request of a subscriber who has received the protected messages; and correlating the key with the messages so as to track the messages.

### PRIORITY STATEMENT UNDER 35 U.S.C.S. 119(e) & 37 C.F.R.S. 1.78

This non-provisional patent application claims priority based upon the prior U.S. provisional patent application entitled “USING DRM TO FINGERPRINT MESSAGES AND CAMPAIGNS”, application No. 61/243,811 filed Sep. 18, 2009, in the name of Jonas Johansson.

### TECHNICAL FIELD

The present invention generally relates to sharing and tracking messages in communication systems.

### BACKGROUND

Nowadays, since the penetration rate for mobile devices in many countries is high, the network operators in those countries need to introduce more and more Value-Added-Services (VAS) in order to maintain their number of clients/subscribers and continue to innovate and make money.

For example, the network operators can enter into partnership with different content providers, such as advertisement content providers and multimedia content providers, in order to offer VAS and promotions to their subscribers.

In such cases, a network operator can agree with an advertisement company, for example, to channel advertisements and other promotional material to its subscribers in exchange of a certain benefit.

Current solutions for this situation comprise a content provider which supplies a campaign (of advertisements and/or promotional material) to the network to be transmitted to a list of distribution (of subscribers) provided by the network operator. For each download of the advertisements and/or promotional material by a subscriber of the list, the network operator gets paid by a certain amount of money or other compensation, for example.

However, such solutions are not accurate in terms of tracking the messages of the campaign sent to the subscribers and thus it is not possible to obtain a good feedback of the campaign. Indeed, a subscriber, who has received the advertisements and/or promotional material, can decide to forward them to his/her friends, who are other subscribers of the network operator but not part of the distribution list, for example. In this case, the number of forwarded advertisements and/or promotional material is not counted and cannot be tracked. Especially, in a viral campaign where subscribers are encouraged to forward the content of the campaign, such as a promotional offer or a funny video/picture, to as many people as possible, using the current solutions, the success of the viral campaign will not be accurately measured.

Thus, there is a need for improving solutions about message/content sharing among subscribers and tracking the message/content.

### SUMMARY

According to a first aspect of the present invention, there is provided a method for sharing multimedia content protected by RM by a first subscriber with at least one second subscriber of a communication system. The method comprises: receiving the protected multimedia content by the at least one second subscriber from the first subscriber, who previously received the multimedia content; and requesting a license key for unlocking the protected multimedia content by the at least one second subscriber. Furthermore, requesting the license key allows for correlating the license key with the multimedia content.

According to a second aspect of the present invention, there is provided a mobile node for sharing multimedia content protected by Rights Management (RM) by a first subscriber with at least one second subscriber in a communication system. The mobile node comprises: an input module for receiving the protected multimedia content from the first subscriber who previously received the protected multimedia content; and an output module for requesting a license key for unlocking the protected multimedia content. Furthermore, requesting the license key allows for correlating the license key with the multimedia content.

According to a third aspect of the present invention, there is provided a method for tracking messages in a communication system. The method comprises: protecting the messages through RM (Rights Management); granting a license key to unlock the protected messages upon request of a subscriber receiving the protected messages; and correlating the license key with the messages so as to track the messages.

According to a fourth aspect of the present invention, there is provided a network node for tracking messages in a communication system. The network node comprises: a RM module for protecting the messages, a license server for granting a license key to unlock the protected messages upon request of a subscriber who has received the protected messages; and a correlating module for correlating the license key with the messages so as to track the messages.

### BRIEF DESCRIPTION OF THE DRAWINGS

In the appended drawings:

FIG. 1 is a schematic view of a communication system in which embodiments of the present invention can be carried out;

FIG. 2 is a flow chart illustrating a method for sharing multimedia content between a first subscriber and at least one second subscriber, according to an embodiment of the present invention;

FIG. 3 is an example of a first subscriber forwarding a multimedia content to a second subscriber according to an embodiment of the present invention;

FIG. 4 is a mobile node for sharing multimedia content between a first subscriber and at least one second subscriber, according to an embodiment of the present invention;

FIG. 5 is a flow chart illustrating a method for tracking messages in the communication system of FIG. 1, according to an embodiment of the present invention;

FIG. 6 is a network node for tracking messages in the communication system of FIG. 1, according to an embodiment of the present invention; and

FIG. 7 is a flow chart illustrating a detailed method for tracking messages in the communication system of FIG. 1, in the context of a viral campaign, according to an embodiment of the present invention.

### DETAILED DESCRIPTION

Generally stated, embodiments of the present invention allow for sharing multimedia content with other subscribers through the use of Rights Management (RM), such as Digital Rights Management (DRM). By so doing, the multimedia content can be tracked in terms of who downloaded and viewed/opened the multimedia content and how many times the multimedia content has been downloaded and viewed. For example, after a subscriber downloads the multimedia content, he/she can forward the multimedia content to a second subscriber. In order to open the multimedia content, both subscribers need to request a key, used by RM or DRM to protect the multimedia content, in order to unlock the downloaded or forwarded multimedia content. In the request, an ID from the subscriber, such as his/her Mobile Subscriber ISDN (MSISDN), can be provided, for example.

It should be noted that by multimedia content, it is meant any content or message comprising video, audio, image, text or a combination thereof.

The embodiments of the present invention are useful when applied to tracking a viral campaign, for example. A viral campaign usually comprises a message whose content is designed in such a way as to make people want to share it with others, i.e. it is intended to spread like a virus, in an infectious way. For example, the content of the message can comprise a video or image that is funny or a very attractive promotional material.

Using current solutions, it is possible to track how many recipients of the message of the campaign have downloaded it on their mobile device, for example. However, it is not possible to track how many recipients actually opened the message of the campaign, and how many recipients forwarded the message to others, who may subsequently open and/or forward the message. Furthermore, if the message of the campaign is shared or forwarded over Bluetooth or outside a network operator's Multimedia Messaging Service (MMS) domain, then, tracking of the message may become difficult. Indeed, in these situations, the recipient of the forwarded message generally needs to access a WAP browser and to support the reception of a WAP push for example, in order to unlock the content of the forwarded message. If not, then tracking is not possible for this forwarded message.

In case the campaign involves paying the network operator for each message opened by a subscriber, it is not possible to generate a report to accurately charge for this campaign through the current solutions. Furthermore, it is not possible to retain any demographic data of the campaign once the campaign is over. The embodiments of the present invention solve those problems and drawbacks.

An example of Rights Management (RM) is given by DRM. DRM has been introduced by Open Mobile Alliance 1.0 (OMA 1.0) and OMA 2.0 and allows generally for restricting distribution of downloaded contents, such as music, movies, games, etc. Also, DRM allows for forward lock, meaning that a downloaded content usually cannot be forwarded to other people/devices. A DRM module, according to OMA 1.0, usually comprises three components: an acquisition unit for receiving a content, a storage unit for storing the received content, and a first key generator which generates a key to encrypt the content as a media object having a content ID. Then, a right object is also generated by the DRM module, for specifying the rights and conditions of use of the media object. The key used to encrypt the media object is put into the right object. The right object also contains the content ID to the media object for which the rights apply. The DRM module may also comprise a second key generator for generating a license key, used to encrypt the right object, for example. This license key allows ultimately for unlocking the content. More specifically, for each DRM-protected content (media object), the second key generator generates a license key for each device that requests to view the protected content. It should be noted that there exists several implementations about how the DRM module protects a multimedia content and how to unlock the protected multimedia content. For example, the generation of the keys can be content based, device based, a combination of both, etc.

Furthermore, through RM or more specifically DRM protection, each protected content of a campaign is identified by a content ID, for example. RM and DRM are well-known in the art and thus will not be describer further.

However, in order to solve the above-mentioned problems and drawbacks about accurately tracking messages of a campaign, RM can be applied in such a way as to allow for tracking messages of a campaign, such as a viral campaign, through the correlation of an ID of the subscribers with the forwarded and opened messages and with their corresponding license keys generated by a RM module, such as a DRM module, as will be described hereinbelow.

It should be noted that in the embodiments of the present invention, DRM will be used as an example of RM. However, other kinds of RM can be used as well and are within the scope of the present invention.

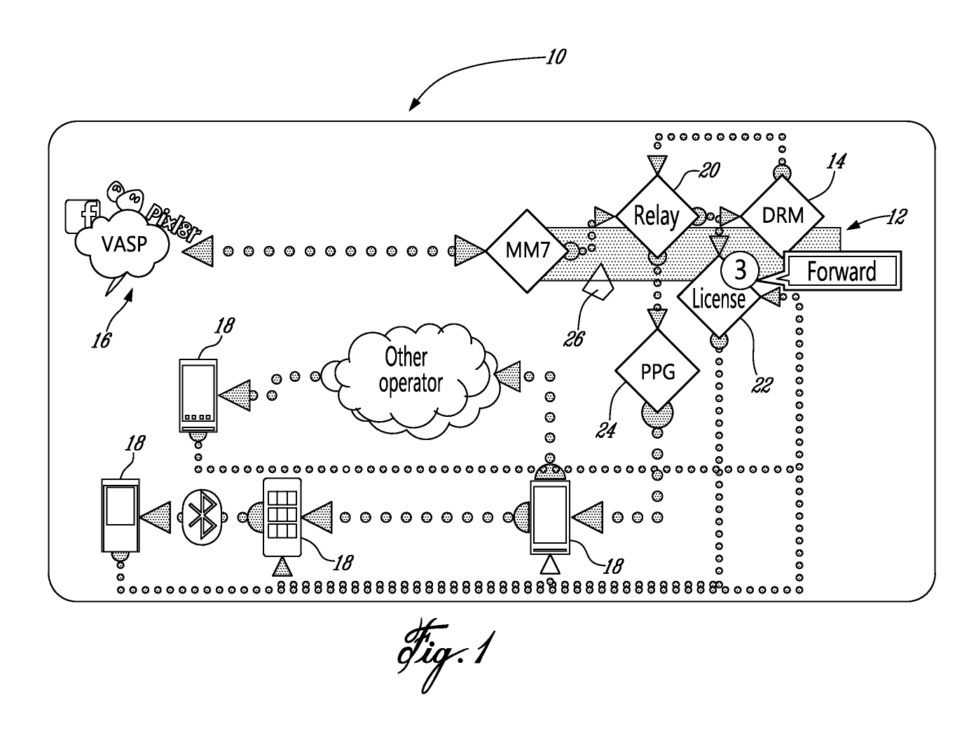

Now, turning to FIG. 1, an exemplary schematic high-level view of a communication system 10 will be described.

More specifically, FIG. 1 shows that the communication system 10 comprises a Multimedia Messaging Center (MMC) 12 for providing Multimedia Messaging Services (MMS). The MMC 12 may include a RM module, more specifically a DRM module 14 for protecting multimedia contents passing through the MMC 12. However, it should be noted that the DRM module 14 can be located inside the MMC 12 or located outside the MMC 12 in another network node (not shown) or can be even a stand-alone unit, in communication with the MMC 12.

The MMC 12 can further comprise a relay 20 (or a traffic node), and a license server 22. The relay 20 is connected to the DRM module 14 and the license server 22.

The MMC 12 may also comprise a correlating module 26, according to an embodiment of the present invention and which will be described hereinbelow.

The MMC 12 is connected to a content provider 16 on one end and is connected to mobile devices 18 on the other end.

In particular, the MMC 12 is in charge of receiving multimedia contents from the content provider 16, using the interface MM7 for example, and transmitting the multimedia content to the mobile devices 18.

When the MMC 12 receives a multimedia content, it is passed to the relay 20. If the multimedia content of the content provider 16 does not need to be protected through DRM, it is sent directly to a Push Proxy Gateway (PPG) 24, which pushes notifications to the mobile devices 18 to notify them of the multimedia content. However, if the multimedia content needs to be protected through DRM, for tracking purposes for example, then the relay 20 sends the multimedia content to the DRM module 14 in which the multimedia content is encrypted for protection. It should be noted that there exists several implementations of how the DRM module can protect a multimedia content. An example of protection is given hereinbelow. However, RM or DRM protection is not restricted to such an example. For instance, when protecting the multimedia content, the DRM module 14 encrypts the multimedia content so as to yield a media object, to which a corresponding content ID and right object are associated. Then license keys can be generated and assigned to the content ID. The generation of the license keys can be device based, meaning that a unique license key is generated for each mobile device 18 that requests for the license key. The unique license key generated for each mobile device 18 allows for unlocking the protected multimedia content identified by the content ID, through the right object, which contains a private key used to encrypt the multimedia content. The license keys can be pre-generated for each of the subscribers belonging to a list of distribution, based on the MSISDN of each subscriber, for example. Those license keys are then sent from the DRM module 14 to the license server 22 for distribution, through WAP Push for example, upon request of a mobile device. 18. However, a license key can be also generated upon request of a subscriber, who is not part of the list of distribution but who has received a forwarded message, for example.

It should be noted that the DRM can use other ways to protect the multimedia content and the generation of the license keys can be content based, so that a single key is generated and used by all the mobile devices 18, for example.

Then, the protected multimedia content is distributed by the MMC 12 through the relay 20 to the list of subscribers, who first receive a notification from the PPG 24, for example. Alternatively, the protected multimedia content can be found on a web site and is ready to be downloaded by the subscribers/users.

When the subscribers receive the notification for the multimedia content, they may decide to download the protected multimedia content. In order to open or unlock the protected multimedia content, they need to request a corresponding license key. If the subscribers subsequently forward the protected multimedia content to other subscribers, those ones also need to request their corresponding license key. When granting or requesting the corresponding license keys through the license server 22, a correlation is made in the correlating module 26, between the license keys and the multimedia content of the campaign (through its content ID) and the ID of the subscribers so as to track the multimedia content of a campaign properly, as will be described hereinbelow.

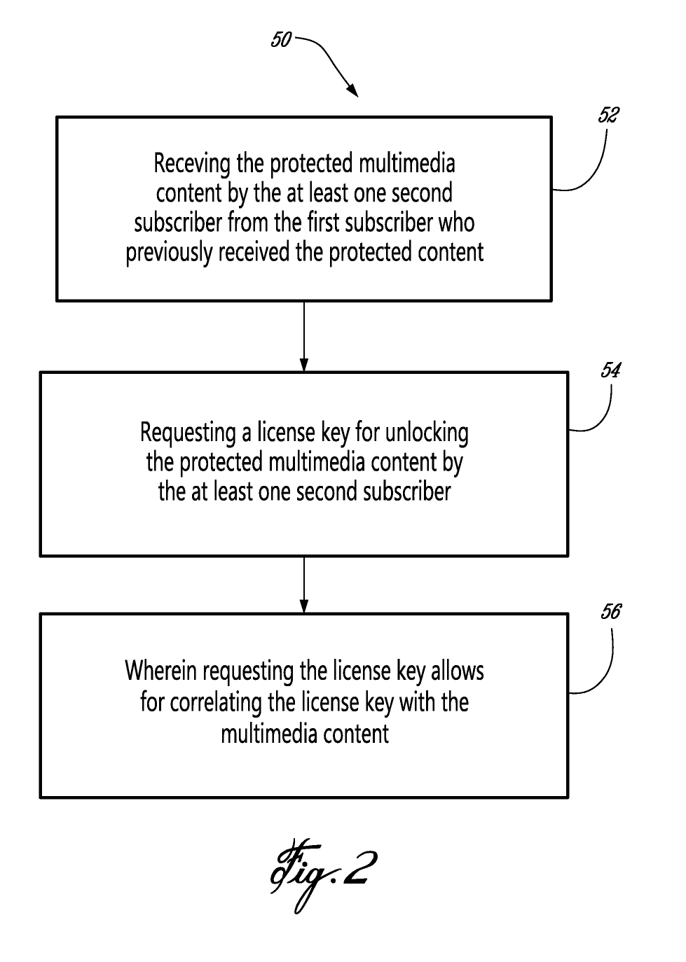

Now, turning to FIG. 2, a method 50 for sharing multimedia content protected by RM by a first subscriber with at least one second subscriber of a communication system, such as the communication system 10 of FIG. 1, will be described. As mentioned hereinabove, DRM protection is given as an example. DRM protection has been described hereinabove. The protected multimedia content can be unlocked through a license key, generated based on each device that asks for the license key, for example.

Method 50 starts with step 52 where the at least one second subscriber receives the protected multimedia content in his/her mobile device 18, for example. The at least one second subscriber receives the protected multimedia content from the first subscriber, who could have downloaded the multimedia content from a web site for example, or could have previously received it through the MMC 12, which had received the content from the content provider 16.

In order to open the received protected multimedia content, the at least one second subscriber needs to request a corresponding license key, from the license server 22, which was generated by the DRM module 14 of FIG. 1, for unlocking the received multimedia content. Thus, in step 54, the at least one second subscriber requests for the license key. Furthermore, in the request, the ID of the second subscriber, such as the MSISDN is provided.

In step 56, through the step of requesting for the license key, a correlation is made between the license key and the multimedia content, in the correlating module 26.

The first subscriber also needs to request a corresponding license key for unlocking the multimedia content that he/she first received. He/she can first request the corresponding license key, before forwarding the multimedia content to the second subscriber, or the first subscriber can first forward the multimedia content to the second subscriber and then request the corresponding license key for unlocking its received multimedia content.

Once the second subscriber receives the forwarded multimedia content, he/she can right away request the corresponding license key for unlocking the multimedia content or he/she can further forward the multimedia content to at least a third subscriber (or other subscribers) and then ask for the corresponding license key from the license server 22, for example.

Alternatively, in order to enhance the subscribers or end users' experience, it is also possible to send the corresponding license key ahead of the multimedia content in the communication system 10. For example, before the MMC 12 sends out the multimedia content of a campaign to the first subscriber, the corresponding license key used to unlock the protected multimedia content can be first sent to the first subscriber. When the multimedia content later arrives to the first subscriber, the mobile device 18 of the first subscriber can see that it has a matching/corresponding license key and thus can unlock the multimedia content right away. In other words, the previously received license key can detect that it can unlock the newly received multimedia content. Therefore, in this case, the first subscriber does not need to request the license key, which can be helpful in cases where the first subscriber does not have data access on his/her mobile device 18.

It should be noted that in the above case, the corresponding license keys have been pre-generated by the DRM module 14 for the subscribers on the list of distribution, using a device-based generation for the license keys, for example. This is possible since the ID of the subscribers of the list is usually already known by the network or the MMC 12.

In the same manner, in his/her request for the license key, the first subscriber can also indicate his/her desire to forward his/her downloaded multimedia content to at least one second subscriber by providing the ID of the second subscriber. In this case, the DRM module 14 can decide to first generate the corresponding license key and send it to the at least one second subscriber, who then will receive subsequently the multimedia content from the first subscriber. Thus, the second subscriber does not need to request for the license key.

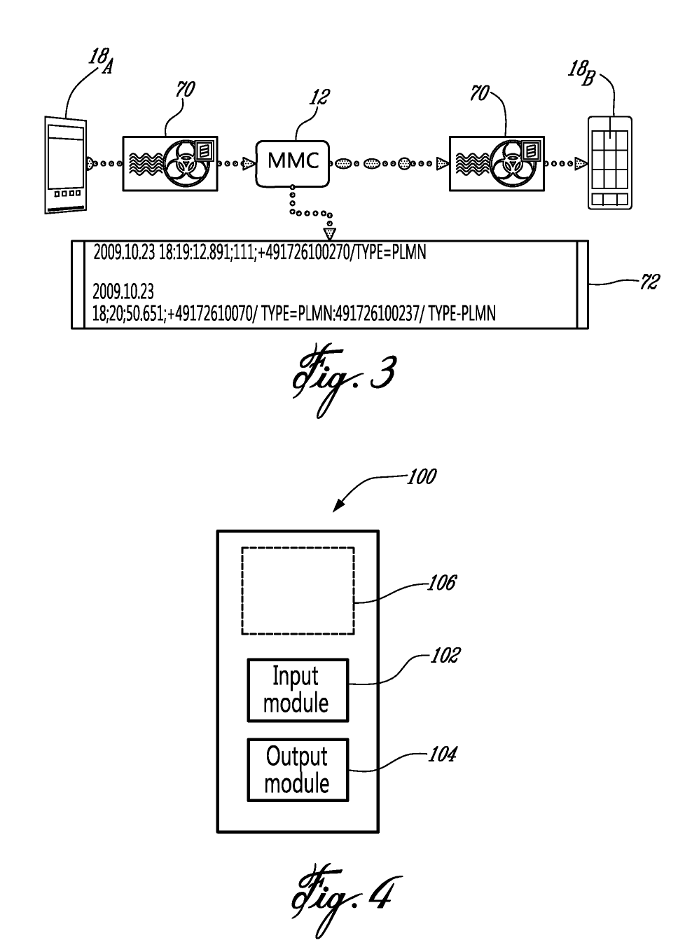

More specifically, FIG. 3 illustrates a detailed example of the first subscriber referred to as 18_{A} forwarding the multimedia content, as a MMS message 70, to the second subscriber 18_{B}.

When forwarding the MMS message 70 from the first subscriber 18_{A} to the second subscriber 18_{B}, the MMS message 70 goes through the MMC 12. When the MMC 12 receives it, it reads the data in the header of the MMS message 70, such as the “To, From, Time, Date” fields and the content ID. The header can be a Multipurpose Internet Mail Extensions (MIME) header. Then, the correlating module 26 (not shown in FIG. 3) correlates the content ID of the multimedia content 70 with the campaign and the ID of the subscribers. Also, the MMC 12 logs in a repository 72 the recorded fields (“To, From, Time, Date”) and the content ID of the message of the campaign to be tracked, for example. Those data can be used in connection with other data for producing and creating different reports, files, statistics about the subscribers, the success of the campaign, etc.

Finally, the MMC 12 can decide to send the license key, through the license server 22, right away to the second subscriber 18_{B} so that when the MMS message 70 is delivered to him/her subsequently, he/she does not need to request for the corresponding license key. It should be noted that this step can be skipped if the network operator decides that each subscriber receiving the multimedia content should ask himself/herself for the corresponding license key.

More specifically, it should be noted that through the requesting/granting of the key, a correlation is made between each received and/or forwarded message (through their content ID), the ID of the subscribers and the corresponding license key. Indeed, when the first and second subscribers request for the license key, their ID, such as their MSISDN, is sent to the MMC 12.

This correlation allows for tracking the number of opened messages, including the forwarded messages and thus allows for measuring accurately the success of the campaign. Also, through the tracking, the list of distribution of subscribers can be tuned in order to determine the top subscribers who forward the most messages, for example. These top subscribers can then be rewarded by receiving credits, for example, and also be marked as good forwarders in the list of distribution. This information can be used as new inputs for further campaigns, especially in viral campaigns. For example, through the correlation, the number of forwards per MSISDN can be counted.

Furthermore, social graphs can be produced through the tracking of forwarded messages. For example, a graph can show the connection between subscribers through a sequence of message forwarding. Indeed, each time that a subscriber sends a request for the license key to unlock the multimedia content, the request contains an ID of the subscriber, such as the MSISDN. Also, when the MMC 12 receives a forwarded message, it records the “to field” which indicates to whom the multimedia content will be forwarded and the “from field” for indicating from whom the multimedia content came.

The information can be recorded by the MMC 12, or the license server 22. The MMC 12 then generates a log repository having data such as “date, time, to, from, etc.” and stores them in a report.

It should be noted that other fields and methods can be used for providing the same information.

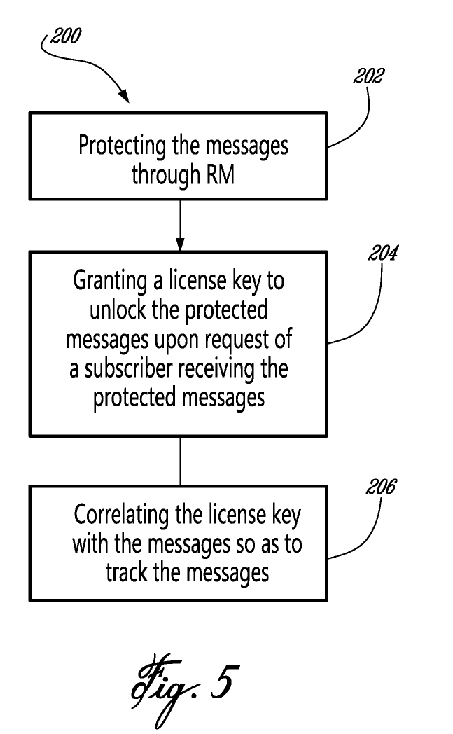

Now, turning to FIG. 4 and with reference to FIG. 1, a mobile node 100, such as the mobile device 18, for sharing multimedia content protected by RM or DRM by a first subscriber with at least one second subscriber in the communication system 10, for example, will be described.

The mobile node 100 comprises an input module 102 for receiving the protected multimedia content from the first subscriber. The first subscriber may have downloaded the protected multimedia content from a website or received it from the MMC 12 of FIG. 1. The mobile node 100 also comprises an output 104 for requesting a license key from the license server 22 for unlocking the protected multimedia content. As mentioned above, the license key can be also requested before the arrival of the multimedia content. In the request, the ID, such as the MSISDN, of the subscriber is provided. The input 102 then receives the license key, which is used to unlock the protected multimedia content. When providing the license key, a correlation is made between the license key, the ID of the subscriber and the multimedia content. Since the license key is correlated to the ID of the subscriber and the multimedia content (through the content ID), it is then possible to track or count the number of messages/multimedia contents that have been opened and forwarded.

It should be noted that the mobile node 100 may also comprise a screen 106 and a plurality of other components (not shown), such as a processor and/or memory, for performing tasks and procedures of the present invention and other usual tasks and procedures well known in the art.

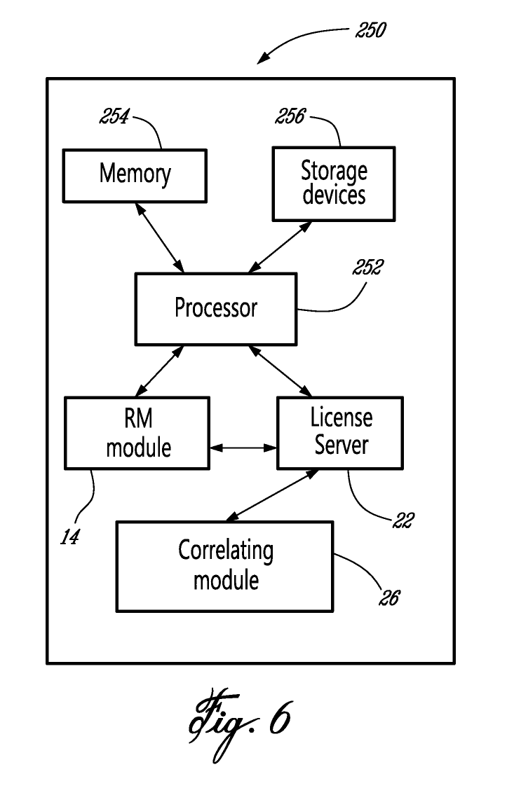

In FIG. 5 and with reference to FIG. 1, a method 200 for tracking messages in the communication system 10 is illustrated.

For example, messages from a campaign are submitted to the MMC 12 for distribution to a list of subscribers.

Once the MMC 12 receives the messages, method 200 starts with step 202 where the messages are protected through RM or more specifically DRM. In this case, the DRM module 14, when receiving a message, coming from the content provider 16, for example, encrypts the received message, and a content ID is assigned to the protected message. Once the messages are protected, they are sent out by the MMC 12 to a list of subscribers, through separate delivery according to OMA 1.0 or through super distribution according to OMA 2.0. Furthermore, as mentioned above, license keys can be generated by the DRM module 14 in order to unlock the protected messages, the license keys being generated based on each mobile device asking for the license key. The license keys are then transmitted to the license server 22.

When a subscriber receives the protected message, he/she can ask the license server 22 for the corresponding license key in order to unlock the content of the received message. In his/her request, his/her ID, such as the MSISDN, can be provided. Then, in step 204, upon receiving the request for the license key, the license server 22 grants the corresponding license key to the subscriber by sending it to him/her.

It should be noted that the license key can be given to the subscriber before he/she receives the message, as an alternative.

When granting the license key, a correlation is made between the license key and the message. Also a correlation between the license key and the subscriber through his/her ID is made. Thus, the granting of the license key to unlock the protected messages allows for tracking the messages of the campaign. Whether the subscriber receives the message from the MMC 12 or another subscriber, any open or forwarded message can be tracked through the license key acquisition. Therefore, the correct number of opened messages can be counted and an accurate picture of the success of a campaign can be determined, for example. Also, by correlating the license key with the ID of the subscribers, the list of distribution can be analyzed and subscribers who forward or open the most messages can be identified for further purposes and campaigns.

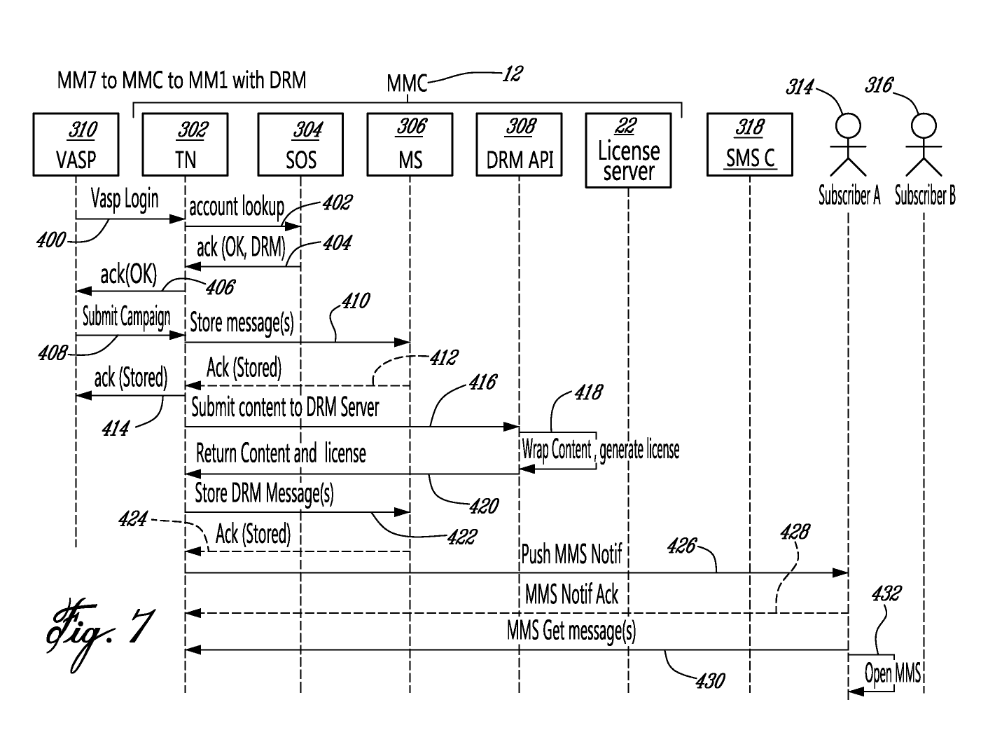

Now, turning to FIG. 6, a network node 250, for tracking messages in the communication system 10 will be described.

The network node 250 can contain a processor 252 (or multiple processor cores), a memory 254, one or more secondary storage devices 256, a RM module (or more particularly the DRM module 14), the license server 22 and a correlating module, such as the correlating module 26. The network node 250 can protect the messages of a campaign using the DRM module 14, as explained hereinabove, for example. The license server 22 allows for granting the corresponding license keys needed for unlocking the protected messages, upon request of the subscribers. The network node 250 can also correlate the granted license keys with the messages and the ID of the subscribers who ask for the license keys through the correlating module 26. This correlation allows for tracking the messages. The correlation can be used by the MMC 12 to further produce reports and statistics in terms of the number of downloaded messages and success of a viral campaign, for example.

Therefore, the network node 250 can perform the functions of a DRM module, a license server as well as correlating the key with the messages, as a single node. Alternatively, if these functions are split between various messaging nodes, the network node 250 can perform those functions as needed.

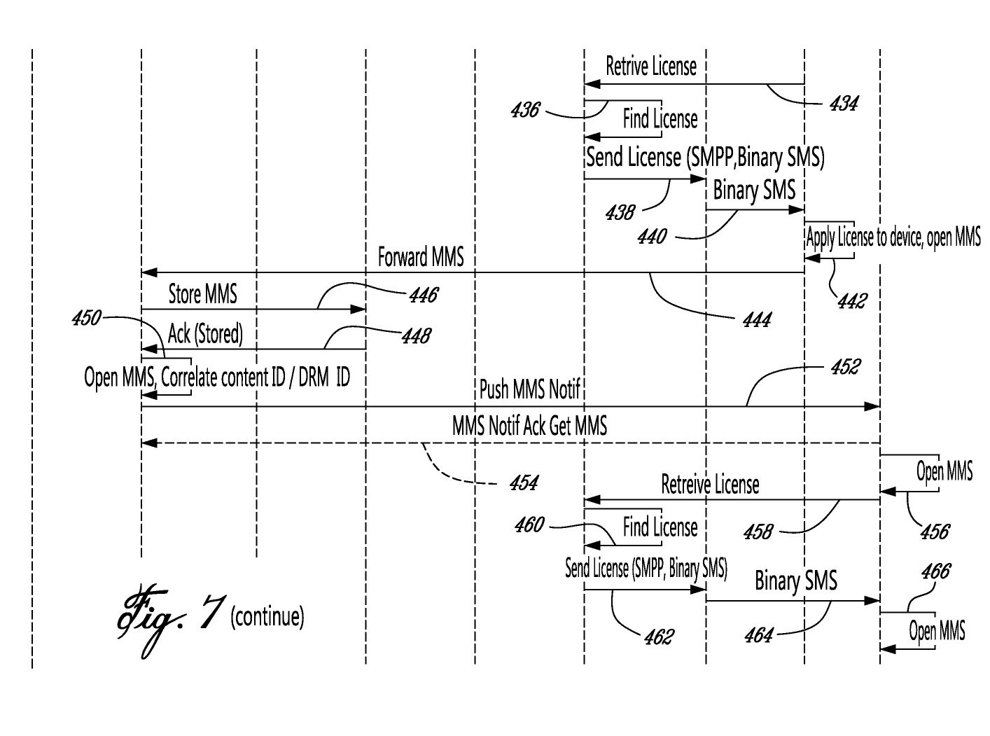

Now, turning to FIG. 7, a detailed example of method 200 for tracking messages in the communication system 10 will be described in the context of a viral campaign, launched by an advertising company, for example. It should be noted that other contexts can be also considered. In this example, DRM is used as one of the RM means. The content of the messages is protected by DRM. License keys are generated based on each mobile device for unlocking the protected messages. In another embodiment, the message is protected based on the content ID and a same key is generated for every mobile device 18, for example.

More specifically, the MMC 12 may comprise a Traffic Node 302 (such as the Relay 20), a subscriber database (SOS) 304 for storing information/profiles of the subscribers, a Message Store (MS) 306 for storing messages received from the campaign, an Application Programming Interface (API) 308 to the DRM module 14 (not shown in FIG. 7), and the license server 22 as described hereinabove.

First, the content provider 16 submits a viral campaign to the MMC 12. To do so, in step 400, the content provider 16, which can be represented generally by a Value-Added Service Provider 310, using for example the interface MM7, logs into the TN 302 of the MMC 12. Then, in step 402, the TN 302 asks the SOS 304 to do an account lookup to ensure that the content provider 16 is registered with the MMC 12. The SOS 304 checks the account and if it is ok, an acknowledgment is sent back to the TN 302 from the SOS 304, in step 404. Then, the TN 302 forwards the acknowledgment to the VASP 310 in step 406.

Upon receipt of the acknowledgment, the VASP 310 submits the viral campaign comprising a message such as a multimedia content, to the TN 302, in step 408.

Then, the TN 302 sends the message to the MS 306 for storage, in step 410. Once the message of the viral campaign has been stored, the MS 306 sends an acknowledgment to the TN 302 in step 412. The TN 302 then forwards it to the VASP 310 in step 414.

In step 416, the message of the viral campaign is sent to the DRM module 14 through the API 308. Upon receipt of the message, the DRM module 14 protects the content of the message, through encryption and generates a corresponding license key for each subscriber on a list of distribution, in step 418.

The protected content along with the corresponding license keys are returned to the TN 302 in step 420. The TN 302 then stores the DRM-protected message in the MS 306 in step 422. An acknowledgment is issued from the MS 306 to the TN 302, in step 424.

In step 426, a MMS notification is pushed from the TN 302 to the subscriber A 314 for informing the subscriber A 314 about the message of the viral campaign.

In step 428, subscriber A 314 sends an acknowledgment for the notification to the TN 302 and then in step 430 sends a MMS message to the TN 302 to request the message of the viral campaign.

In step 432, the subscriber A 314 opens the MMS message and then in step 434 requests its corresponding license key from the license server 22 in order to open the content of the message of the viral campaign.

In step 436, the license server 22 finds the appropriate/corresponding license key and then sends it to the Short Messaging Service Center (SMS-C) 318, for example, as a binary SMS, in step 438. It is assumed that subscriber A 314 belongs to the list of distribution.

It should be noted that through the request and granting of the license key, a report can be produced for the viral campaign by the MMC 12. The ID of the subscriber A 314 requesting the license key is correlated with the ID of the content of the message of the viral campaign for example. Thus, it is possible to track how many people/subscribers have downloaded and opened the content of the message through the granting of the license key.

The binary SMS containing the license key is sent to the subscriber A 314 in step 440. Upon receipt of the binary SMS, the subscriber A 314 applies the license key to his/her mobile device 18 and thus can open the content of the message of the campaign, in step 442. It should be noted that other sending means are also possible for transmitting the corresponding license key to the subscriber A 314. It is not restricted to SMS.

After the subscriber A 314 opens the content of the message, which can be text, video, image, etc., he/she likes it and desires to share it with subscriber B 316.

In his/her desire to forward the MMS containing the message of the viral campaign to subscriber B 316, the MMS first goes to the TN 302, in step 444.

The TN 302 asks the MS 306 to store it, in step 446. An acknowledgment is issued from the MS 306 to the TN 302, in step 448. Then, in step 450, the TN 302 opens the MMS and performs a correlation between the content ID and the ID of the viral campaign to make sure that the content ID belongs to the current viral campaign.

In step 452, a MMS notification is pushed to the subscriber B 316, to which the subscriber B 316 replies with an acknowledgment and requests for the message in step 454.

In step 456, the subscriber B 316 opens the received MMS message. Then, she/he asks for the license key in step 458 from the license server 22.

The license server 22, upon receipt of the request, asks the DRM module 14 to generate the license key based on the mobile device of subscriber B 316. In this case, it is assumed that subscriber B 316 is not part of the list of distribution, therefore no corresponding license key was pre-generated for him/her. Once the license key is generated, the license key is sent to the license server 22, which receives the license key in step 460. Then in step 462, the license server 22 sends the license key as a binary SMS, for example, to the subscriber B 316.

In step 466, the subscriber B 314 opens the content of the message upon receipt of the license key. The subscriber B 316 can then forward the message to further subscribers using the same steps (steps 444 to 466) as described hereinabove, for example.

It should be noted that when each subscriber retrieves the license key from the license server 22, a correlation of the license key (having a serial number, for example) and the MSISDN of the subscriber is made, as well as a correlation between the license key and the message. The correlation can be then documented in a report. The report can be transmitted to the content provider 16 at the end of the viral campaign.

Thus, it is now possible to track how many people have read each message of the campaign and how many messages each subscriber of the distribution list has forwarded to other people. Also, each message can be tracked so as to indicate where the message comes from and where it is forwarded to, for example.

By so doing, a better feedback and measure of success of the viral campaign can be achieved.

Another context for embodiments of the present invention is concerned with sharing multimedia contents, such as music or movies, among at least a first and second subscribers.

Usually, such contents are protected by DRM. So, when a user downloads a multimedia content, from a web site, for example, he/she keeps it for himself/herself. The user cannot share his/her download with friends. Also, often times, it can be cumbersome and long to download a multimedia content from the content provider, through the web site.

However, using an embodiment of the present invention, it is possible for a subscriber to share his/her downloaded content protected by DRM with other friends. To do so, each subscriber who gets a copy of the content, through the forwarding of another subscriber, still needs to get a key from a license server in communication with a DRM module in order to be able to render the content. However, instead of going himself/herself to the web site to download the content, the subscriber can get the content from a friend of his/hers, for example.

It should be noted that embodiments of the present invention can be also applied to track voice messages in Mobile communications Over Internet Protocol (MoIP).

Modifications and other embodiments of the disclosed invention will come to mind to one skilled in the art having the benefit of the teachings presented in the foregoing description and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method for sharing multimedia content protected by Rights Management (RM) by a first subscriber with at least one second subscriber in a communication system, the method comprising:
receiving the protected multimedia content by the at least one second subscriber from the first subscriber, who previously received the multimedia content; and
requesting a license key for unlocking the protected multimedia content by the at least one second subscriber;
wherein requesting the license key allows for correlating the license key with the multimedia content.

2. A method as defined in claim 1, wherein receiving the protected multimedia content comprises receiving a content selected from the group consisting of text, audio, video, image and a combination thereof.

3. A method as defined in claim 1, wherein receiving the protected multimedia content by the at least one second subscriber occurs before the first subscriber requests a corresponding license key for unlocking the protected multimedia content that the first subscriber has previously received.

4. A method as defined in claim 1, wherein receiving the protected multimedia content by the at least one second subscriber occurs after the first subscriber requests a corresponding key for unlocking the protected multimedia content that the first subscriber has previously received.

5. A method as defined in claim 1, wherein requesting the license key comprises providing an ID of the at least one second subscriber.

6. A method as defined in claim 5, wherein the ID of the at least one second subscriber comprises a MSISDN.

7. A method as defined in claim 1, further comprising receiving the license key for unlocking the protected multimedia content before receiving the protected multimedia content by the at least one second subscriber from the first subscriber.

8. A method as defined in claim 7, wherein upon receiving the protected multimedia content, the previously received license key detects that it can unlock the newly received multimedia content.

9. A method as defined in claim 5, wherein requesting the license key allows for correlating the ID of the at least one second subscriber with the multimedia content.

10. A method as defined in claim 1, wherein receiving the protected multimedia content comprises providing a field for indicating from whom the protected multimedia content came and another field for indicating to whom the multimedia content is forwarded.

11. A mobile node for sharing multimedia content protected by Rights Management (RM) by a first subscriber with at least one second subscriber in a communication system, the mobile node comprising:
an input module for receiving the protected multimedia content from the first subscriber who previously received the protected multimedia content; and
an output module for requesting a license key for unlocking the protected multimedia content;
wherein requesting the license key allows for correlating the license key with the multimedia content.

12. A mobile node as defined in claim 11, wherein the output first requests for the license key before forwarding the protected multimedia content to at least one third subscriber.

13. A mobile node as defined in claim 11, wherein the output first forwards the protected multimedia content to at least one third subscriber before requesting for the license key.

14. A mobile node as defined in claim 11, wherein the output further sends out an ID of the at least one second subscriber when requesting for the license key.

15. A mobile node as defined in claim 14, wherein requesting the license key further allows for correlating the license key with the multimedia content and the ID of the first subscriber.

16. A mobile node as defined in claim 11, wherein the input further receives the license key before receiving the protected multimedia content.

17. A method for tracking messages in a communication system, the method comprising:
protecting the messages through RM (Rights Management);
granting a license key to unlock the protected messages upon request of a subscriber receiving the protected messages; and
correlating the license key with the messages so as to track the messages.

18. A method as defined in claim 17, wherein protecting the messages through RM comprises protecting the messages through Digital Rights Management (DRM) and encrypting the messages by using at least the license key.

19. A method as defined in claim 17, wherein the request comprises an ID of the subscriber.

20. A method as defined in claim 19, wherein correlating the license key with the messages further comprises correlating the license key with the subscriber through the ID.

21. A method as defined in claim 17, wherein correlating the license key with the messages allows for tracking a number of downloaded and open messages.

22. A method as defined in claim 17, further comprising granting the license key to unlock the protected messages without a request of a subscriber who will subsequently receive the protected messages.

23. A method as defined in claim 17, further comprising recording from the protected message a field for indicating from whom the protected messages came and another field for indicating to whom the messages are forwarded.

24. A network node for tracking messages in a communication system, the network node comprising:
a RM module for protecting the messages;
a license server for granting a license key to unlock the protected messages upon request of a subscriber who has received the protected messages; and
a correlating module for correlating the license key with the messages so as to track the messages.

25. A network node as defined in claim 24, further comprising a log repository for recording information data in a header of the protected messages.
